(19) United States
(12) Patent Application Publication
(10) Pub. No.: US 2011/0073413 A1
(43) Pub. Date: Mar. 31, 2011

(54) Lift and hold device

(76) Inventors: William J. Sturmer, Lemont, IL (US); Robert R. Workman, JR., Tinley Park, IL (US)

(21) Appl. No.: 12/881,088

(22) Filed: Sep. 13, 2010

Related U.S. Application Data
(60) Provisional application No. 61/241,561, filed on Sep. 11, 2009.

(51) Int. Cl. B66B 9/16

(52) U.S. Cl. 187/240

(57) ABSTRACT

This invention relates to a free standing lifting device which means that no additional support is required to support the lifting action of the device. The lifting device comprises a lift carriage further comprising at least one lift arm joined to a motor by way of a cable, at least one lift channel having a lift opening for receipt of the lift arm, at least one support arm and at least one support channel having a support opening for receipt of the support arm.

### FIELD OF INVENTION

This invention relates to lifting and storage device. More specifically, this invention relates to a compact self-standing device that can lift and also hold items of significant weight.

### BACKGROUND OF INVENTION

Lifting and storage devices are well known in prior art. Typically when a heavy, large, or bulky item, such as a pallet needs to be moved, a user will use a forklift to move the pallet into its desired location. However, at times there is a need to move a pallet into position and a forklift is not readily available or accessible to a user. Such a circumstance might be in a restaurant kitchen where space is limited and tight to maneuver large objects. Further, if a forklift or other means of movement isn't available a user may struggle to lift an item into place, putting the user into harm's way. As such there is a need, that this invention meets, for a free standing device that can lift and store large bulky items easily in a desired location.

### SUMMARY OF INVENTION

This invention relates to a free-standing lifting device comprising:
a lift carriage further comprising at least one lift arm joined to a motor by way of a cable;
at least one lift channel having a lift opening for receipt of said lift arm;
at least one support arm; and
at least one support channel having a support opening for receipt of said support arm.

This lifting device is capable of being a free standing device which means that no additional support is required to support the lifting action of the device. However, one skilled in the art will recognize that it is possible to anchor or otherwise secure the lifting device a user the user desire to take that action.

For purposes of describing this invention, the lift carriage will utilize two lift arms joined to a motor. One skilled in the art will recognize that only one lift arm or many lift arms can be used depending on the situation. When the user has an item that needs to be lifted, the lift arms are adjusted within the lift opening within the lift channel. The lift arms are adjustable and/or removable. It is anticipated that many lengths and widths of lift arms can be used depending on the situation.

One example of an item being lifted is in a situation whereby a user desires to lift a pallet. The lift arms support the pallet and the lift carriage is activated by way of a motor by way of a cable. One skilled in the art will recognize that the motor may be electric or hydraulic and that this invention is not confined to using a cable to join the motor to the lift carriage.

Once the lift carriage has reached the desired height, support arms are placed into the support openings within the support channels. These support arms are able to hold the pallet into a secure place until the user desires to move the pallet. This action also frees the lift carriage to be able to lift more items/pallets into a desired position by using the above described system without disturbing the integrity of the system.

The lift carriage can move vertically by way of flange rollers within the lifting device. This allows for smooth movement along the length of the lifting device.

The lift arms and support arms preferably twist lock into position within the respective openings. A twist lock movement is preferred to ensure proper placement and locking of the lift arms or support arms. If a user has to twist a lift arm or support arm into place, it provides an added level of secure support.

Other advantages and aspects of the present invention will become apparent upon reading the following description of the drawings and the detailed description of a preferred embodiment of the invention.

### DETAILED DESCRIPTION OF THE DRAWINGS

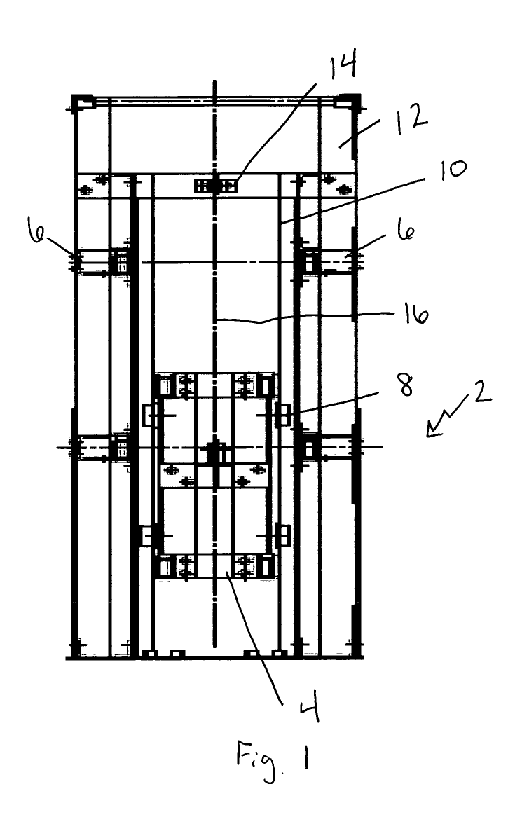

FIG. 1 depicts the free-standing lifting device.

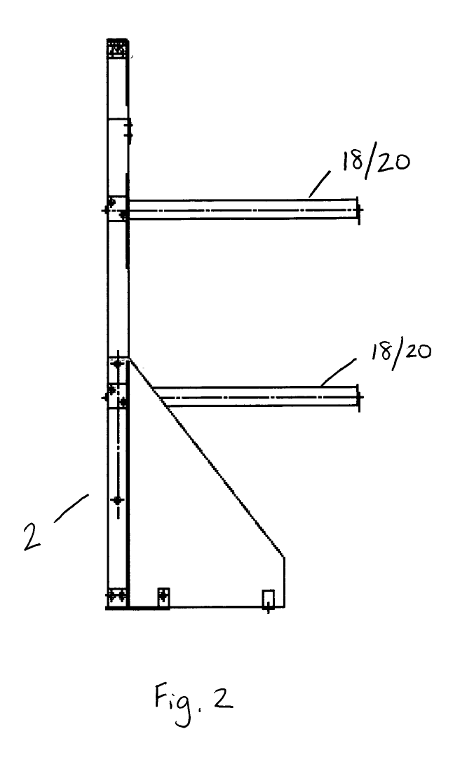

FIG. 2 depicts a side view of the free standing lifting device.

### DETAILED DESCRIPTION OF THE PREFERRED EMBODIMENT

FIG. 1 is a detailed view of the free standing lifting device 2. As seen in FIG. 1, this lifting device 2 comprises a lift carriage 4 comprising at least one lift arm 18 joined to a motor by way of a cable 16, at least one lift channel 10 having a lift opening 8 for receipt of the at least one lift arm 18, at least one support arm 20, and at least one support channel 12 having a support opening 6 for receipt of the support arm 20.

FIG. 1 depicts a situation whereby there are two lift channels 10 and two support channels 12. Each of the two lift channels 10 has at least one lift opening 8. Each of the two support channels 12 has at least one support opening 6. Upon activation of the lifting device 2, a first item (not shown) is position on the lift carriage 4. The arms 18 are adjusted within the lift opening 8 and hold the first item (not shown) into position. The motor 14 drives the lift carriage 4 to a desired height by way of the cable 16.

Once the lift carriage 4 has reached the desired height, the support arms 20 are placed into each of the support openings 6 within the support channels 12. These support arms 20 are able to support the first item (not shown) into a desired position.

If a user desires to lift a second item into position while the first item (not shown) is in place, it is possible to use the lift carriage 4 again for lifting without affecting the integrity of the first item's (not shown) position. This will also not affect the balance or structural integrity of the lifting device 2. The lift arms are again placed into the lift cahnnel by way of the lift opening 8. Once the second item is positioned on the lift arms 18, the motor can again raise the lift carriage 4 into a desired location. Once that location is reached, support arms 20 can be placed into the support channel 12 by way of the support openings 6. Both the first and second items (not shown) can now be supported within the lifting device 2 and the lift carriage 4 is free to lift other items if needed.

It will be appreciated that the embodiments disclosed herein are not limiting on the scope of the invention and that variations and modifications may be made without departing from the spirit and scope of the invention.

What is claimed is:

1. A free-standing lifting device comprising:
a lift carriage further comprising at least one lift arm joined to a motor by way of a cable;
at least one lift channel having a lift opening for receipt of said lift arm;
at least one support arm; and
at least one support channel having a support opening for receipt of said support arm.

2. The free-standing lifting device as in claim 1 wherein at least one lift arm and at least one support arm are removable and/or adjustable.

3. The free-standing lifting device as in claim 2 wherein at least one lift arm is received into the lift channel by way of the lift opening; upon activation of the lift carriage said lift carriage raises or lowers a first item positioned on the at least one lift arm to a desired height.

4. The free-standing lifting device as in claim 3 wherein the first item is supported at the desired height by the at least one support arm being received into the support channel by way of the support opening; said at least one lift arm is capable of being removed from lift channel once said at least one support arm is received into support channel.

5. The free-standing lifting device of claim 4 wherein a second item can be lifted by the at least one lift arm when the first item is supported by the at least one support arm.
